(19) United States
(12) Patent Application Publication
(10) Pub. No.: US 2010/0211865 A1
(43) Pub. Date: Aug. 19, 2010

(54) CROSS-BROWSER PAGE VISUALIZATION GENERATION

(75) Inventors: Michael C. Fanning, Redmond, WA (US); Boris Feldman, Seattle, WA (US); Steven I. Guttman, Mercer Island, WA (US); Tyler G. Simpson, Redmond, WA (US); Erik A. Saltwell, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/388,839

(22) Filed: Feb. 19, 2009

(51) Int. Cl. G06F 17/00

(52) U.S. Cl. 715/234

(57) ABSTRACT

Many web developers spend significant time investigating and/or mitigating inconsistencies that may present when a web page is rendered across different browsers. Most websites are developed for multiple versions of one or more web browser and/or for multiple versions of one or more platforms. As provided herein, a cross-browser page visualization may be generated. A visualization may comprise a Document Object Model (DOM) associated with a screenshot image of a web page rendered within an available browser. Multiple visualizations may be created using locally installed browsers and/or remote browsers. The visualizations provide high-fidelity browser renderings coupled with underlying styling and/or DOM information that may be used to interrogate and/or annotate the screenshot image, thus allowing a web page to be developed that can be desirably rendered on different browsers, different operating systems and/or on different versions of the same.

### BACKGROUND

Users have a variety of web browsers and respective versions of browsers to choose amongst when accessing internet resources (e.g., web pages, web applications, etc.). Different web browsers may interpret and render an internet resource differently, thus causing rendering inconsistencies. For example, one web browser may render an image within a web page at a different position than another web browser. To make matters worse, rendering inconsistencies may be caused by differences amongst operating systems and other settings. A developer may spend significant time investigating and mitigating rendering differences between web browsers. The developer may have to render a web page within multiple browsers, versions, and operating systems to detect rendering inconsistencies.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A technique for generating cross-browser page visualizations is disclosed herein. Initially, a set of available browsers upon which a page may be rendered may be determined. The set of available browsers may comprise local browsers and/or remote browsers. A local browser may be a web browser installed on a user's local machine. A remote browser may be a web browser accessible through a remote web service. The set of available browsers may be determined based upon a user selection (e.g., a user selects browsers that are able to render source code for the purpose of detecting rendering inconsistencies). For respective available browsers within the set of available browsers, source code (e.g., data corresponding to a web page, website, and/or internet resource) may be rendered within the available browser. Rendering may be performed on a user's local machine for local browsers. Rendering may be performed on a respective remote machine for remote browsers.

Rendered data may be captured from the rendered source code. The rendered data may comprise a screenshot image (e.g., an image of the source code rendered within the available browser) and a Document Object Model (DOM) representation. The DOM representation may comprise a hierarchical arrangement of user interface (UI) elements and/or their respective attributes (e.g., position, styling, bounding box attributes, etc.). The DOM representation may be associated with respective pixel coordinates of the screenshot image to create a visualization. For example, a DOM representation may comprise layout information of an image UI element. The layout information may be correlated with and/or superimposed upon respective pixel coordinates of the image UI element within the screenshot image. Associating the DOM representation with the screenshot image provides a visualization comprising enhanced layout information that a static screenshot image would otherwise not provide. At least one visualization may be presented. DOM representations may be normalized across multiple visualizations to create a cross-browser element correlation. Cross-browser element correlation provides information correlating UI elements across multiple visualizations. A user may easily detect inconsistencies based upon additional information derived from the cross-browser element correlation.

Additionally, DOM representations may be augmented with annotations that tie UI elements to original source code locations. Annotation data may comprise mark-up analysis results and/or detailed data regarding layout differences. For example, annotation data may comprise information regarding well-known browser bugs when handling one or more particular mark-ups. The annotation data allows for detailed analysis against the mark-up that may be provided to a user.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of generating cross-browser page visualizations.

FIG. 2 is a component block diagram illustrating an exemplary system for generating cross-browser page visualizations.

FIG. 3 is an illustration of an example of generating cross-browser page visualizations.

FIG. 4 is an illustration of an example of a cross-browser page visualization.

FIG. 5 is an illustration of an example of a cross-browser page visualization.

FIG. 6 is an illustration of an example of multiple cross-browser page visualizations.

FIG. 7 is an illustration of an exemplary computer-readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Many internet resources (e.g., web pages) are intentionally developed and designed to run on one or more browsers and/or on different versions of the same or different browsers (e.g., browser 1, version 1.0; browser 1, version 2.0; browser 2, version 1.0) and often for multiple versions of one or more platforms (e.g., operating system 1 and operating system 2). A browser version may represent a distinct code base with its own rendering characteristics. Browser user settings and/or operating system configurations may also influence rendering. Furthermore, mark-up (e.g., source code representing a web page) may respond differently to a variety of environment conditions (e.g., via JavaScript and other dynamic HTML technologies) that may alter the final rendered version. These rendering inconsistencies may significantly complicate the task of developing internet resources that render consistently for users regardless of the web browser, operating system, and/or other variables.

A developer may devote significant time to investigate and eliminate rendering inconsistencies. Many operating systems and/or web browser versions may be unable to operate within the same computing environment, thus a developer may have to use multiple computing environments (e.g., multiple personal computers) to investigate rendering inconsistencies. As more web browsers and/or versions become available, the task of developing web pages that render consistently across them becomes increasingly time consuming and complicated.

Currently, web authoring tools may comprise a rendering engine configured to render a web page within a few well-established browsers. This approach does not address rendering inconsistencies due to other operating systems, browsers, etc. Another current approach is to provide a preview experience by loading a web page in one or more locally installed browsers. This approach is limited to installed browsers which may be restricted by operating system considerations and/or side-by-side considerations (e.g., a version of a web browser may not install side by side with another version) for various browsers. Yet another current approach is to send the web page to a remote server for processing. This approach may provide a diverse set of browser renderings, but may be limited to providing static images of the rendered web pages. It may be difficult to detect rendering inconsistencies between static images.

Among other things, a technique for generating cross-browser page visualizations is provided herein. Visualizations may be generated based upon captured screenshots and Document Object Model (DOM) representations of source code (e.g., a web page) rendered across an indeterminate set of browsers running locally and/or on remote machines. It may be appreciated that a DOM representation may comprise a hierarchical arrangement of elements within a web page and/or attributes of the elements (e.g., position, styling, bounding box attributes, etc.). To create a visualization, a DOM representation of rendered source code may be associated with respective pixel coordinates of a screenshot image of the rendered source code (e.g., layout information of user interface elements may be superimposed upon their pixel coordinates). Visualizations of the source code rendered within multiple browsers may be presented to a user.

The visualizations provide high-fidelity renderings coupled with underlying HTML data, CSS data, layout information, user interface (UI) element attribute data, etc. Unlike current techniques, the visualization is not just a static screenshot image, but also provides additional information useful for detecting and/or correcting rendering inconsistencies. The user may be presented with multiple visualizations for comparison within a single environment.

A cross-browser element correlation may be created from the DOM representations of respective visualizations. The cross-browser element correlation may be used to correlate layout information and/or other DOM information of UI elements across multiple visualizations. Additional information (e.g., automatic mismatch detection) may be provided to a user based upon the cross-browser element correlation. For example, a user may select a button within a visualization. The cross-browser element correlation may define pixel coordinates and/or underlying layout information of the button within other visualizations. The button may be highlighted within the other visualizations to allow the user to efficient compare and detect rendering inconsistencies of the button.

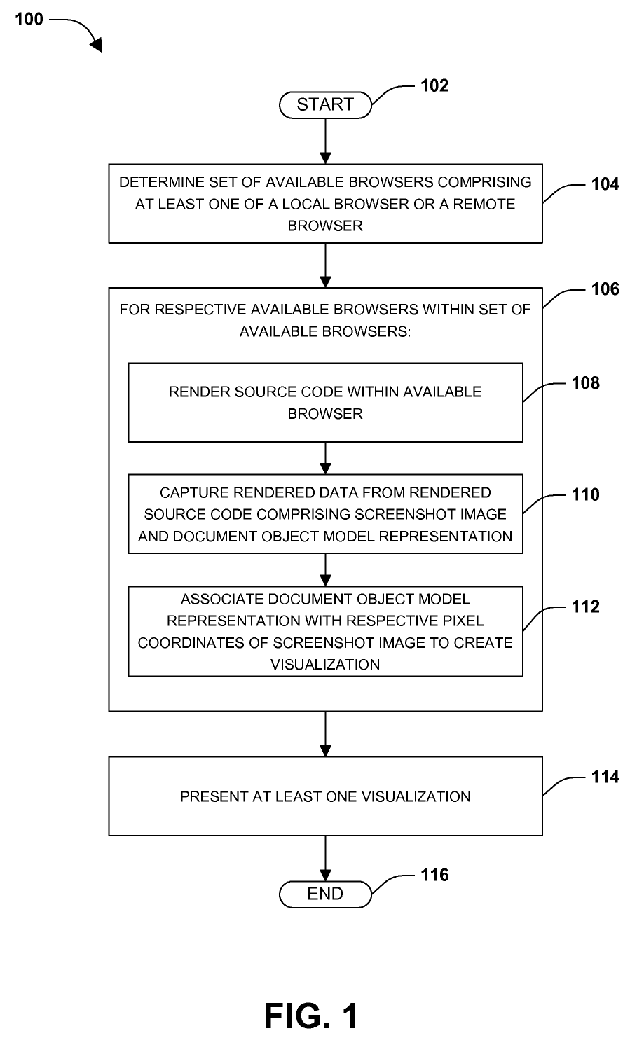

One embodiment of generating cross-browser page visualizations is illustrated by an exemplary method 100 in FIG. 1. At 102, the method begins. At 104, a set of available browsers may be determined. The set of available browsers may comprise local browsers and/or remote browsers. A local browser may be a web browser installed locally on a user's machine. A remote browser may be a web browser installed on a remote machine (e.g., a web service comprising a remote web browser). In one example, the set of available browsers may be determined based upon a user selection of one or more web browsers.

For respective available browsers within the set of available browsers (at 106), source code may be rendered within the available browser, at 108. It may be appreciated that the source code may represent a web page and/or a website (e.g., a website comprising multiple web pages that may be processed as a batch job to increase efficiency). The rendering may be performed on a local machine if the available browser is locally installed. This may increase performance by utilizing local resources. The rendering may be performed on a remote machine (e.g., a remote web service within a cloud computing environment) if the available browser is a remote browser. This allows for a variety of browsers to be available that may not be locally installed.

At 110, rendered data may be captured from the rendered source code (e.g., rendered data may be captured from the rendering at 108). The rendered data may comprise a screenshot image and/or a Document Object Model (DOM) representation. The screenshot may comprise a visual data image of the page as rendered by the available browser (e.g., a snapshot). The DOM representation may comprise CSS data, HTML data, layout information, UI element attribute data (e.g., position, size, border, padding, etc. of a UI element), and/or other data corresponding to the available browser rendering the source code.

At 112, the DOM representation may be associated with respective pixel coordinates of the screenshot image to create a visualization. In one example, the DOM representation may be superimposed with the respective pixel coordinates of the screenshot image. In another example, UI element attribute data within the DOM representation may be correlated with respective pixel coordinates of the UI element within the screenshot image (e.g., layout information of a UI element may be associated with the pixel coordinates of the UI element, layout information may be superimposed upon the pixel coordinates of the UI element, etc.). It may be appreciated that the screenshot image and the DOM representation may be associated in a variety of techniques known to those skilled in the art and are not limited to the examples herein.

At 114, at least one visualization may be presented. It may be appreciated that multiple visualizations may be presented to facilitate comparison of page renderings between browsers. The visualization may comprise a high-fidelity browser rendering (e.g., a screenshot image) coupled with underlying styling and DOM information (e.g., a DOM representation) that may be used to interrogate and/or annotate the screenshot. This may allow for sophisticated visualization and/or analysis features that have the feel of working with an actual working web page of the source code. A user may efficiently detect and/or eliminate rendering inconsistencies because the visualization provides not just a static image that current techniques provide, but additional DOM information. In one example, the DOM representation comprises user UI element attribute data and the screenshot image comprises visual UI elements (e.g., pixel representation of UI elements). The UI element attribute data may be presented as superimposed upon respective pixel coordinates of the visual UI elements within the screenshot image. A user may be able to efficiently compare positional data (e.g., position, border, size, etc.) for a visual UI element across multiple renderings (e.g., multiple visualizations).

To enhance the detection and/or correction of rendering inconsistencies, a mismatch notification may be presented. The mismatch notification may be based upon a mismatch between a primary visualization (e.g., a visualization designated as the desired rendering to which other visualizations are compared to determine mismatches) and one or more other visualizations. For example, a mismatch may be determined by comparing pixel values between multiple visualizations. A mismatch notification may be created if the pixel values between the visualizations exceed a predetermined threshold. In another example, a mismatch may be detected based upon analysis of positional information within DOM information. Mismatches may be detected, for example, by analyzing the positional information without performing pixel-to-pixel comparison. In this way, errors introduced by parent UI elements may be compensated for and/or further analysis of children UI elements may be ceased once layout differences (e.g., a mismatch) of parent UI elements are detected.

In another example, a mismatch may be determined based upon a discrepancy of DOM representation data of a UI element of multiple visualizations. The discrepancy may be determined by comparing UI element attribute data within respective DOM representations. In yet another example, DOM representations may be normalized across visualizations to create a cross-browsers element correlation. The cross-browser element correlation may comprise an aggregate of DOM information, style information, and/or rendering information. The cross-browser element correlation may be analyzed to determine areas of significant deviation (e.g., rendering inconsistencies). Detected deviations may be presented as notifications to the user or they may be automatically corrected.

It may be appreciated that UI elements (e.g., rendered DOM elements) may be tracked in relation to their respective source code through a variety of techniques. In one example, annotations may be created within the source code to designate UI elements. A shortcut from the visual rendering of the UI element within the visualization to the annotation within the source code may be presented. For example, upon determining a rendering inconsistency, a user may use the shortcut to quickly access the corresponding source code through an HTML editor. Again, however, this is merely one example, and other techniques may be envisioned which fall within the scope of the appended claims. At 116, the method ends.

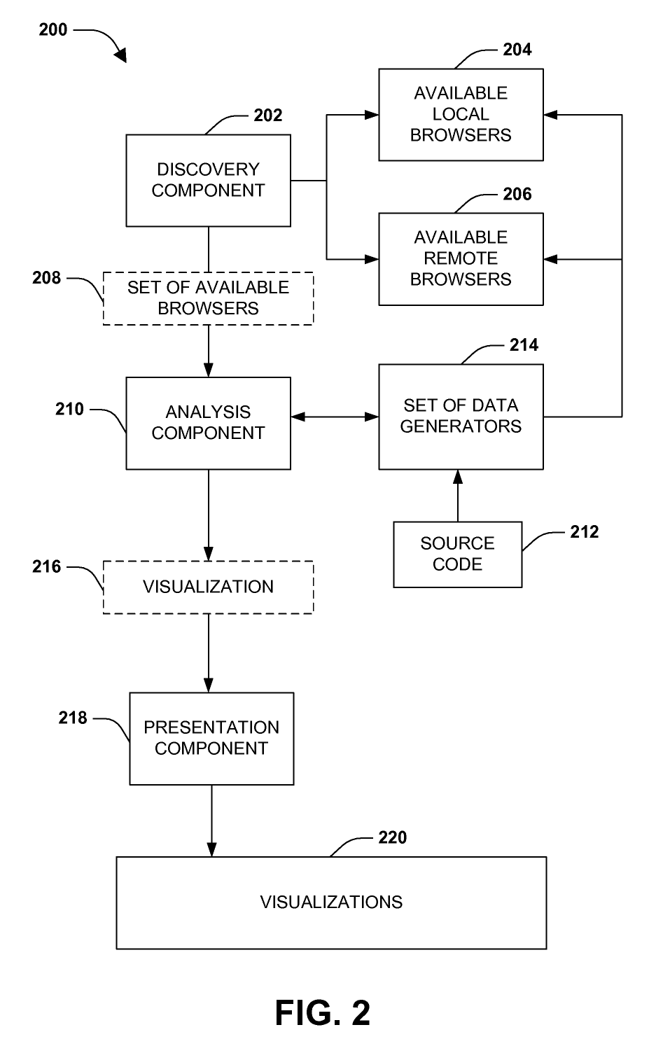

FIG. 2 illustrates an example 200 of a system configured for generating cross-browser page visualizations. The system may comprise a discovery component 202, a set of data generators 214, an analysis component 210, and/or a presentation component 218. The discovery component 202 may be configured to determine a set of available browsers 208. The set of available browsers 208 may comprise local browsers and/or remote browsers. In one example, the set of available browsers 208 may be determined based upon a user selection of available local browsers 204 and/or available remote browsers 206. It will be appreciated that the discovery component 202 may be optional where, for example, the user manually enters (e.g., types, selects) the (path to) the browsers. In another example, the discovery component 202 may automatically populate a set of available browsers 208.

Respective data generators within the set of data generators 214 may be configured to capture rendered data from source code 212 rendered within a particular available browser. The source code 212 may comprise information relating to a web page, website, web application, and/or more than one web page as a batch job. The rendered data may comprise a screenshot image and a Document Object Model (DOM) representation. The set of data generators 214 may comprise remote data generators configured to capture rendered data from the source code 212 rendered within a particular remote browser. The set of data generators 214 may comprise local data generators configured to capture rendered data from the source code 212 rendered within a particular local browser.

In one example of capturing rendered data from a particular remote web browser, source code comprising server-side commands may first be rendered into HTML using a preview server, for example. A remote browser may then render the HTML, which may then be captured. In another example of capturing rendered data from a particular remote web browser, local source code may be packaged up with associated elements that may need rendering. The package may be sent to a remote location comprising the remote web browser. The package may be unpacked and served to the remote web browser for rendering, which may then be captured.

It will be appreciated that a mark-up may undergo transformations on its way to being rendered. Transformations may occur server-side and/or by scripting (e.g., in response to browsers and/or other environment detection (‘sniffs’)). The transformations may present challenges when correlating the original mark-up to a final version of the mark-up as rendered by various browsers and/or configurations. To address these issues, objects models may be acquired and/or created from the original mark-up. The mark-up may be annotated through a variety of techniques to leave markers that may be preserved though transformations. In one example, web resources associated with a page may be closed for annotating. The closed web resources, annotations, and/or other page data may be packaged and sent to a remote server for rendering. To resolve issues arising from dynamic server-side content, for example, content may be streamed through a web server with a particular user-agent string. Furthermore, copies of transformed pages may be preserved for subsequent use. Annotations that survive these techniques may be utilized in correlated DOM elements across pages.

The analysis component 210 may be configured to execute a particular data generator when a corresponding available browser is chosen from the set of available browsers 208. For a particular data generator, the DOM representation may be associated with respective pixel coordinates of the screenshot to create a visualization 216. For example, the analysis component 210 may correlate the DOM representation with the screenshot image to create the visualization 216. In another example, the analysis component 210 may superimpose user interface (UI) element attribute data (e.g., layout information within the DOM representation) upon corresponding pixel coordinates within the screenshot image.

The analysis component 210 may be configured to normalize DOM representations across multiple visualizations to create a cross-browser element correlation. For example, a first DOM representation may be normalized relative to one or more other DOM representations (e.g., second, third and/or fourth, etc.) to create a cross-browser element correlation. It will be appreciated that while “first” and “second”, etc. designations are, for example, used herein for different elements or components (e.g., DOM representations), that these are merely used for clarity and ease of understanding (e.g., to differentiate and/or identify the different elements). They are not, however, meant to limit the scope of the subject matter claimed herein. That is, a limitation of a one to one (1:1) correspondence is not to be inferred. For example, a correspondence between a first and a second should not be limited to just that first and that second, but should instead generally be interpreted as a correspondence between that first and one or more seconds (e.g., a single second is merely used herein because it simplifies the discussion.)

The cross-browser element correlation may be used to highlight a user selected user interface (UI) element within multiple visualizations. The cross-browser element correlation may be analyzed to determine rendering inconsistencies between multiple visualizations, thus enhancing a user's ability to detect rendering inconsistencies. For example, the cross-browser element correlation may comprise layout information of UI elements for respective visualizations. For respective UI elements, the layout information may be compared between visualizations to determine rendering inconsistencies. In one example, UI elements with rendering inconsistencies may be highlighted. In another example, the rendering inconsistencies may be automatically corrected. In yet another example, a user may be presented with a mismatch notification of the inconsistencies.

The presentation component 218 may be configured to present at least one visualization (e.g., visualizations 220). The user may be able to detect, compare, and/or correct rendering inconsistencies using the visualizations 220. The visualizations 220 provide not only screenshots of the browser rendering, but also additional information (e.g., mismatch notifications, DOM representations associated with screenshot images, cross-browser element correlation data) useful in detecting and/or correcting rendering inconsistencies. For example, a mismatch notification may be presented based upon determining a mismatch between visualizations. The system may also comprise a code tracking component configured to create annotations designating source code corresponding to UI elements within the source code 212. A shortcut may be presented within a visualization (e.g., respective pixel coordinates of a UI element within the screenshot image) to a corresponding annotation within the source code 212.

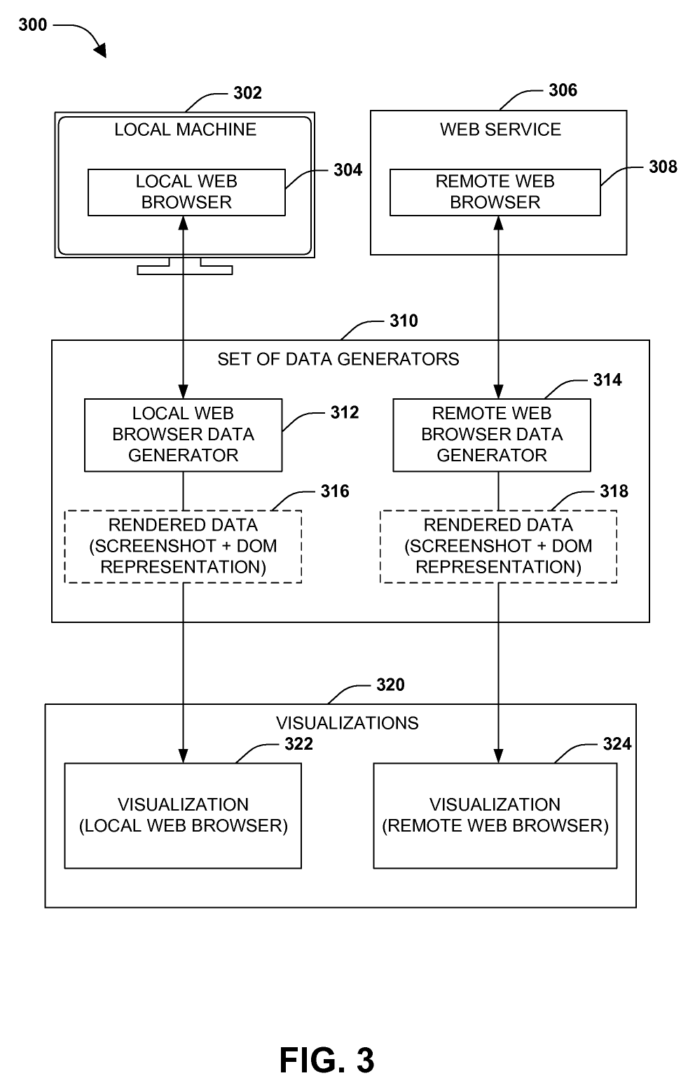

FIG. 3 illustrates an example 300 of generating cross-browser page visualizations. A local machine 302 may comprise a local web browser 304. A web service 306 may comprise a remote web browser 308. A set of available browsers may comprise the local web browser 304 and/or the remote web browser 308. For example, a user may select the local web browser 304 and the remote web browser 308 from a list of available browsers. It may be appreciated that more than one browser may be locally and/or remotely available.

A set of data generators 310 may comprise a local web browser data generator 312 and/or a remote web browser data generator 314. The local web browser data generator 312 may be configured to capture rendered data 316 from the local web browser 304. The remote web browser data generator 314 may be configured to capture rendered data 318 from the remote web browser 308. For example, a user may create a news website. It may be determined that website visitors may access the news website using a web browser corresponding to the local web browser 304 and/or a web browser corresponding to the remote web browser 308 (e.g., a distinct installation of a similar version of the web browsers). To check for rendering inconsistencies between the two web browsers, the user may desire visualizations of the local web browser 304 and the remote web browser 308. It may be appreciated that a particular remote web browser may be located on the Internet, an Intranet, or on a local network.

The local web browser data generator 312 may capture the rendered data 316 from the local web browser 304 rendering source code (e.g., a news website). The rendered data 316 may comprise a screenshot image of the visual appearance of the rendered source code and a DOM representation (e.g., underlying layout information) of the rendered source code. The remote web browser data generator 314 may capture the rendered data 318 from the remote web browser 308 rendering the source code. The rendered data 318 may comprise a screenshot image and a DOM representation of the rendering. It will be appreciated that the generated screenshot image may or may not be captured from a literal screenshot. For example, source code may launch a browser to acquire the screenshot image, thus a user may not actually see the screenshot image until after it has already been captured.

For respective rendered data (e.g., rendered data 316 and rendered data 318), the DOM representation may be associated with the screenshot image to create a visualization (e.g., a visualization 322 of the local web browser 304 rendering and a visualization 324 of the remote web browser 308 rendering). For example, a news website may be rendered within the local web browser 304. The screenshot image comprises pixels corresponding to a visual rendering of UI elements within the news website (e.g., a button, a header, a label, etc.). The DOM representation may comprise a hierarchical representation of the UI elements and/or their respective layout information (e.g., size, position, padding, etc.). The layout information of a particular UI element may be associated with the pixels corresponding to the particular UI element.

The visualization 322 and/or the visualization 324 may be presented 320 to a user. Respective visualizations may provide a user with a screenshot image coupled with underlying layout information. The user may utilize this information to detect rendering inconsistencies (e.g., visually and/or through the layout information). The DOM representations between the visualizations may be normalized to create a cross-browser element correlation. The cross-browser element correlation may be utilized to provide information of UI elements across multiple renderings. For example, a user may be presented with a mismatch notification derived from a cross-browser element correlation. The mismatch notification may specify that a position of a button UI element differs between the visualization 322 and the visualization 324.

It will be appreciated that the DOM representations may or may not be normalized. For example, the original mark-up may merely be annotated rather than normalizing DOM representations. The annotations may be preserved throughout mark-up transformations, thus allowing tags to be correlated without regard to intervening changes that might have occurred during scripting alterations, server-side changes, etc.

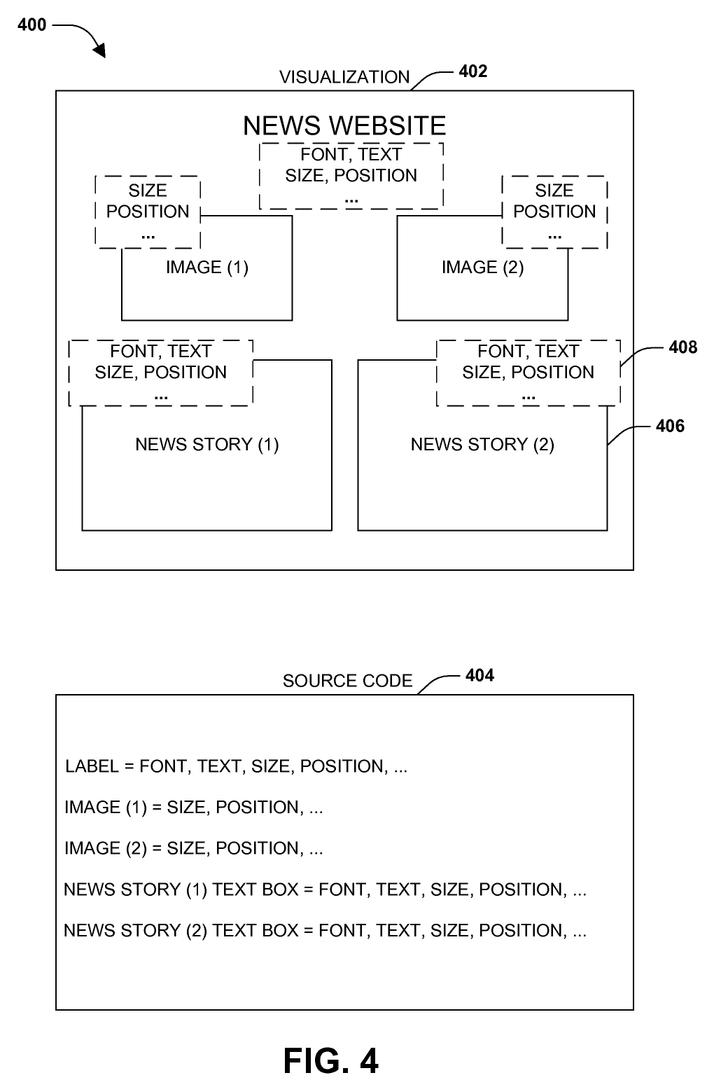

FIG. 4 illustrates an example 400 of a cross-browser page visualization. A visualization 402 may be presented to a user. The visualization 402 may comprise a DOM representation associated with a screenshot image of source code 404 (e.g., a news website) rendered within an available browser. The screenshot image may comprise pixels corresponding to UI elements (e.g., news story (2) text box 406). The DOM representation may comprise user interface (UI) element attribute data (e.g., news story (2) layout information 408).

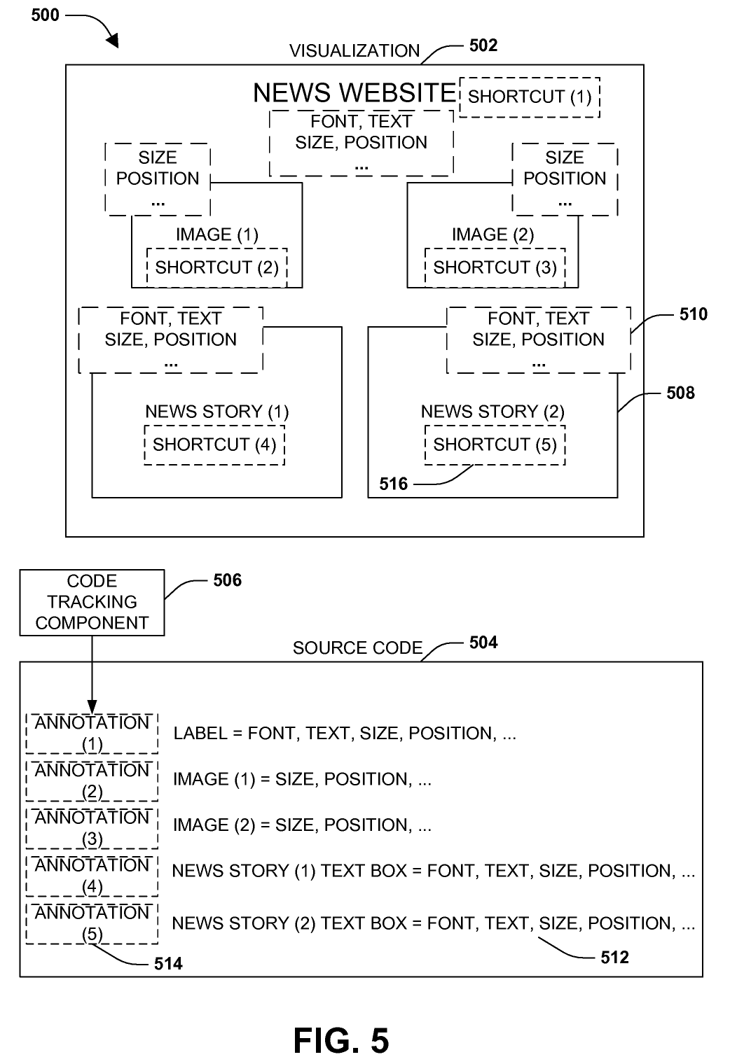

FIG. 5 illustrates an example 500 of a cross-browser page visualization. A visualization 502 may be presented to a user. The visualization may comprise a DOM representation associated with a screenshot image of source code 504 (e.g., a news website) rendered within an available browser. The screenshot image may comprise pixels corresponding to UI elements (e.g., news story (2) text box 508). The DOM representation may comprise user interface (UI) element attribute data (e.g., news story (2) layout information 510).

A code tracking component 506 may be configured to create annotations within the source code 504. For example annotation (5) 514 may be created to designate source code 512 corresponding to the news story (2) text box 508 (e.g., a UI element). The code tracking component 506 may be configured to present a shortcut (5) 516 from respective pixel coordinates of the news story (2) text box 508 to the annotation (5) 514. This allows a user to quickly switch between viewing the visualization 502 to the source code 504 for editing (e.g., edit the source code 504 to correct rendering inconsistencies).

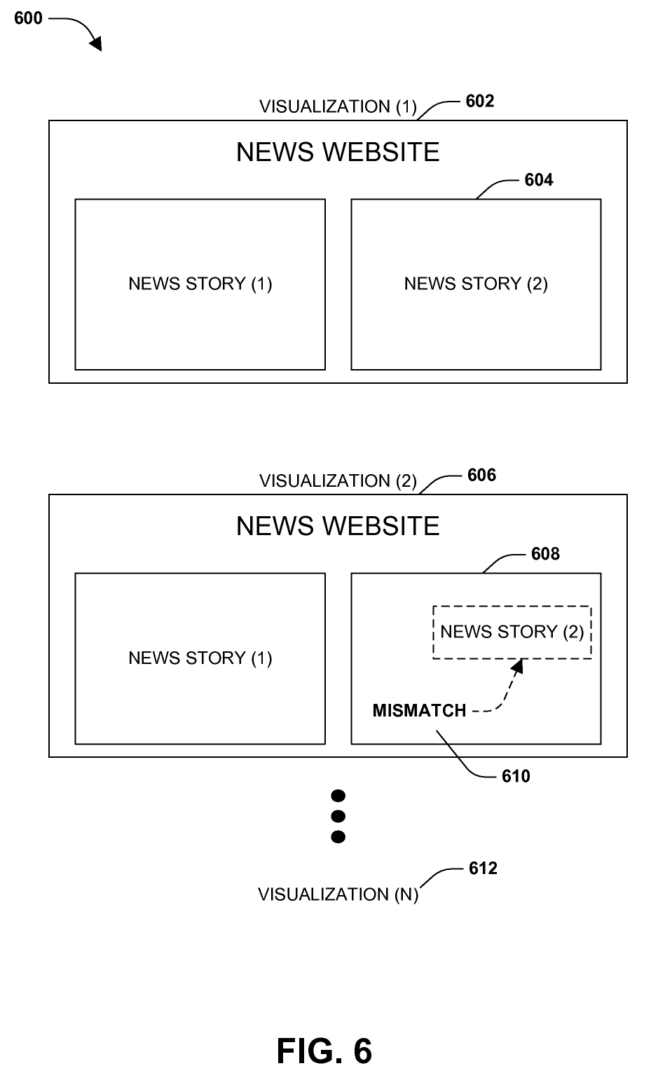

FIG. 6 illustrates an example 600 of multiple cross-browser page visualizations. A visualization (1) 602, a visualization (2) 606, and/or other visualizations (e.g., visualization (N) 612) may be presented. The visualizations may pertain to a news website rendered within respective available browsers. The news website may comprise user interface elements (e.g., news story (1) text box, news story (2) text box, etc.). Respective visualizations may comprise a DOM representation associated with a screenshot image. The DOM representations of the visualizations may be normalized to create a cross-browser element correlation. The cross-browser element correlation may be analyzed to determine rendering inconsistencies (e.g., a mismatch between visualizations).

In one example, the visualization (1) 602 comprises a screenshot image associated with a DOM representation of a news website. The DOM representation may be normalized with DOM representations of other visualizations to create a cross-browser element correlation. The cross-browser element correlation may be analyzed to determine layout information regarding a news story (2) text box 604 within the visualization (1) 602 is inconsistent with layout information of a news story (2) text box 608 with the visualization (2) 606. A mismatch notification 610 may be presented to notify a user that a rendering inconsistency may exist with regards to a news story (2) text box rendered within the visualization (1) 602 and the visualization (2) 606. The mismatch notification may provide the user with enhanced information (e.g., highlighted inconsistencies, actual layout data of inconsistencies, etc.) that a static screenshot image would otherwise not provide.

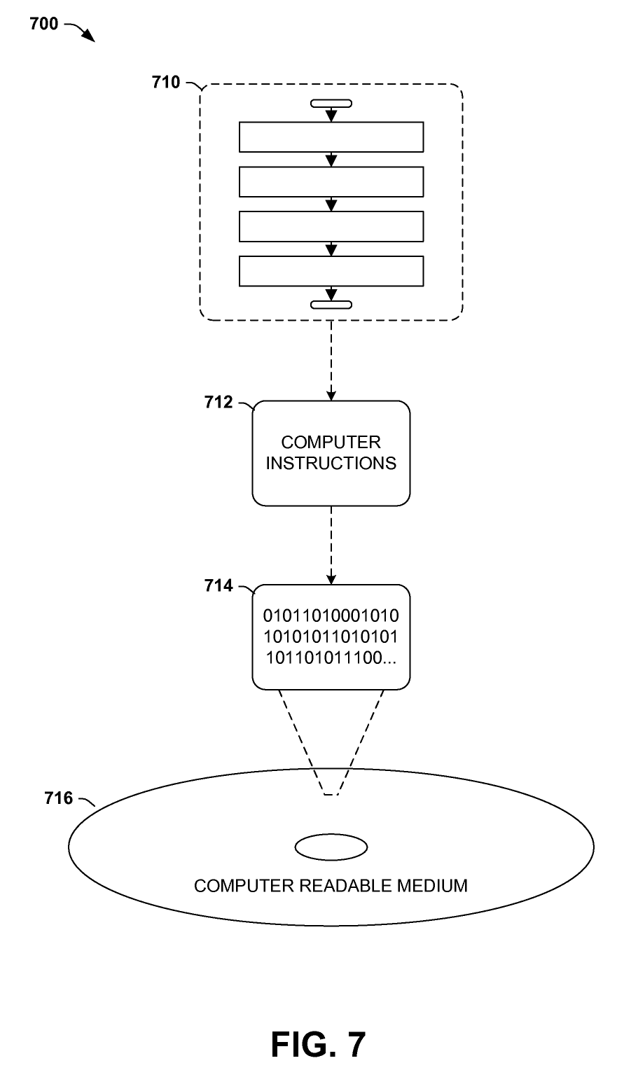

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 716 (e.g., a CD-R, DVD-R, or a platter of a hard disk drive), on which is encoded computer-readable data 714. This computer-readable data 714 in turn comprises a set of computer instructions 712 configured to operate according to one or more of the principles set forth herein. In one such embodiment 700, the set of computer instructions 712 may be configured to perform a method, such as the exemplary method 100 of FIG. 1, for example. In another such embodiment, the set of computer instructions 712 may be configured to implement a system 710, such as the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

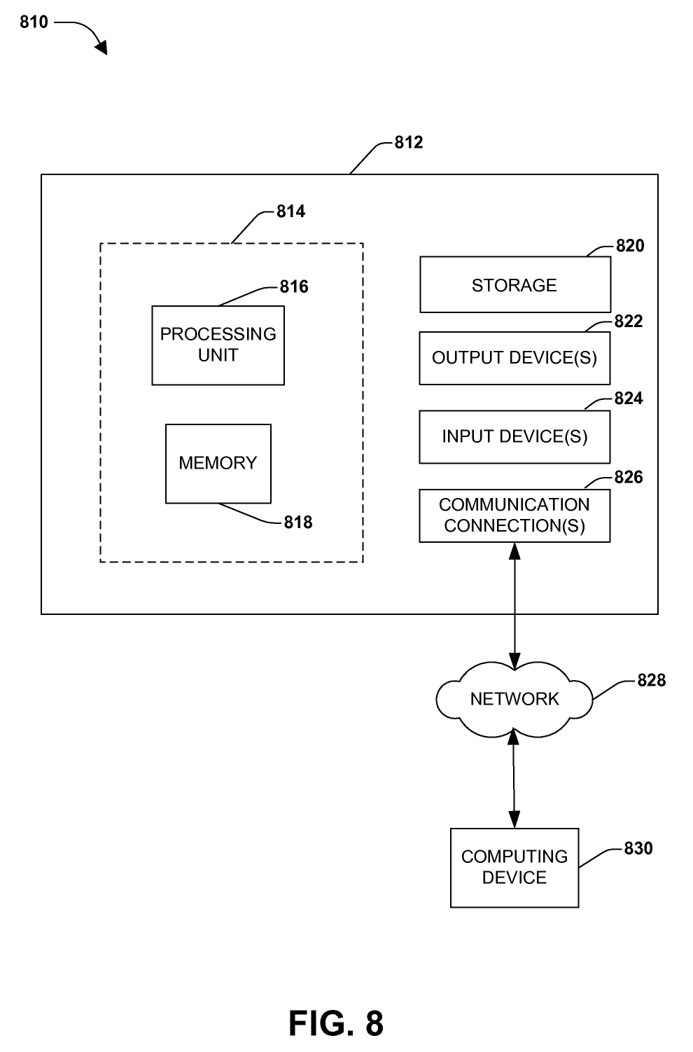

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such features may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for generating cross-browser page visualizations comprising:
determining a set of available browsers comprising at least one of:
a local browser; and
a remote browser;
for respective available browsers within the set of available browsers:
rendering source code within the available browser;
capturing rendered data from the rendered source code, the rendered data comprising a screenshot image and a Document Object Model (DOM) representation; and
associating the DOM representation with respective pixel coordinates of the screenshot image to create a visualization; and
presenting at least one visualization.

2. The method of claim 1, comprising:
normalizing a first DOM representation and a second DOM representation to create a cross-browser element correlation.

3. The method of claim 1, the associating comprising superimposing the DOM representation and the respective pixel coordinates of the screenshot image.

4. The method of claim 1, the associating comprising correlating user interface (UI) element attribute data within the DOM representation with respective pixel coordinates of a UI element within the screenshot image.

5. The method of claim 1, the rendering comprising:
rendering a first source code on a local machine within a local browser; and
rendering a second source code on a remote machine within a remote browser.

6. The method of claim 1, the DOM representation comprising at least one of:
CSS data;
HTML data;
hierarchical arrangement of user interface (UI) elements;
layout information; and
UI element attribute data.

7. The method of claim 1, the source code comprising more than one web page as a batch job.

8. The method of claim 1, comprising:
creating an annotation within the source code to designate source code corresponding to a user interface (UI) element.

9. The method of claim 8, comprising:
presenting a shortcut from respective pixel coordinates of the UI element within the screenshot image to the annotation within the source code.

10. The method of claim 1, the DOM representation comprising user interface (UI) element attribute data and the screenshot image comprising visual UI elements.

11. The method of claim 10, the presenting comprising:
presenting the UI element attribute data superimposed upon respective pixel coordinates of the visual UI elements within the screenshot image.

12. The method of claim 1, comprising:
presenting a mismatch notification based upon a mismatch between a first visualization and a second visualization.

13. A system for generating cross-browser page visualizations comprising:
a discovery component configured to determine a set of available browsers comprising at least one of:
a local browser; or
a remote browser;
a set of data generators, respective data generators configured to capture rendered data from source code rendered within a particular available browser, the rendered data comprising a screenshot image and Document Object Model (DOM) representation;
a analysis component configured to:
execute a particular data generator when a corresponding available browser is chosen from the set of available browsers; and
for the particular data generator, associate the DOM representation with respective pixel coordinates of the screenshot to create a visualization; and
a presentation component configured to present at least one visualization.

14. The system of claim 13, the set of data generators comprising:
a remote data generator configured to capture rendered data of source code rendered within one or more remote browsers; and
a local data generator configured to capture rendered data of source code rendered within one or more local browsers.

15. The system of claim 13, the analysis component configured to superimpose the screenshot image and the DOM representation to create a visualization.

16. The system of claim 13, the analysis component configured to normalize a first DOM representation and a second DOM representation to create a cross-browser element correlation.

17. The system of claim 13, the visualization comprising user interface (UI) element attribute data superimposed upon pixel coordinates of respective visual user interface (UI) elements within the screenshot image.

18. The system of claim 13, comprising
a code tracking component configured to:
create an annotation within the source code to designate source code corresponding to a user interface (UI) element; and
present a shortcut from respective pixel coordinates of the UI element within the screenshot image to the annotation within the source code.

19. The system of claim 13, the presentation component configured to present a mismatch notification based upon determining a mismatch of respective rendering data between a first visualization and a second visualization.

20. A system for generating cross-browser page visualizations comprising:
a discovery component configured to determine a set of available browsers comprising at least one of:
a local browser; or
a remote browser;
a set of data generators, respective data generators configured to capture rendered data from source code rendered within a particular available browser, the rendered data comprising a screenshot image and Document Object Model (DOM) representation;
a analysis component configured to:
execute a particular data generator when a corresponding available browser is chosen from the set of available browsers; and
for the particular data generator, associate the DOM representation with respective pixel coordinates of the screenshot to create a visualization; and
normalize a first DOM representation and a second DOM representation to create a cross-browser element correlation;
a presentation component configured to:
present at least one visualization; and
present a mismatch notification based upon determining a mismatch within the cross-browser element correlation between a first visualization and a second visualization; and
a code tracking component configured to:
create an annotation within the source code to designate source code corresponding to a user interface (UI) element; and
present a shortcut from respective pixel coordinates of the UI element within the screenshot image to the annotation within the source code.
